(19) United States
(12) Patent Application Publication
(10) Pub. No.: US 2024/0020873 A1
(43) Pub. Date: Jan. 18, 2024

(54) IMAGE GENERATION SYSTEM, IMAGE GENERATION METHOD, AND RECORDING MEDIUM

(71) Applicant: NEC Corporation, Minato-ku, Tokyo (JP)

(72) Inventor: Hiroshi HASHIMOTO, Tokyo (JP)

(21) Appl. No.: 18/026,479

(22) PCT Filed: Sep. 25, 2020
(86) PCT No.: PCT/JP2020/036345

§ 371 Date: Mar. 15, 2023

(51) Int. Cl. G06T 7/73; G06T 5/00; G06V 10/776

(52) U.S. Cl. CPC G06T 7/73; G06T 5/001; G06V 10/776; G06T 2207/30201; G06V 40/165

(57) ABSTRACT

An image generation system includes: a detection unit that detects a position information about a position of a face or a position of a feature point of the face from an image; an acquisition unit that obtains a perturbed position information that takes into account an error that occurs when the position information is detected, for the position information; and a generation unit that generates a new image including the face on the basis of the perturbed position information. According to such an image generation system, it is possible to properly generate a new image in view of the error in position estimation.

### TECHNICAL FIELD

This disclosure relates to an image generation system, an image generation method, and a recording medium that generate an image.

### BACKGROUND ART

A known system of this time generates a face image on the basis of a feature point of a face. For example, Patent Literature 1 discloses a technique/technology of normalizing a face such that both eyes are at a predetermined reference position, and cutting out an image including the normalized face.

As another related technique/technology, for example, Patent Literature 2 discloses a technique/technology of learning a neural network by using a feature extracted from learning data as an adversarial feature. Patent Literature 3 discloses a technique/technology of specifying a person of a face image on the basis of a registered face template and probability distribution sample data. Patent Literature 4 discloses a technique/technology of generating a perturbed face image by rotating a face image.

### CITATION LIST

### Patent Literature

Patent Literature 1: JP2007-226424A

Patent Literature 2: PCT International Publication No. WO2018/167900

Patent Literature 3: JP2005-208850A

Patent Literature 4: JP2017-182459A

### SUMMARY

### Technical Problem

This disclosure improves the related techniques/technologies described above.

### Solution to Problem

An image generation system according to an example aspect of this disclosure includes: a detection unit that detects a position information about a position of a face or a position of a feature point of the face from an image; an acquisition unit that obtains a perturbed position information that takes into account an error that occurs when the position information is detected, for the position information; and a generation unit that generates a new image including the face on the basis of the perturbed position information.

An image generation method according to an example aspect of this disclosure includes: detecting a position information about a position of a face or a position of a feature point of the face from an image; obtaining a perturbed position information that takes into account an error that occurs when the position information is detected, for the position information; and generating a new image including the face on the basis of the perturbed position information.

A recording medium according to an example aspect of this disclosure is a recording medium on which a computer program that allows a computer to execute an image generation method is recorded, the image generation method including: detecting a position information about a position of a face or a position of a feature point of the face from an image; obtaining a perturbed position information that takes into account an error that occurs when the position information is detected, for the position information; and generating a new image including the face on the basis of the perturbed position information.

### BRIEF DESCRIPTION OF DRAWINGS

FIG. 1 is a block diagram illustrating a hardware configuration of an image generation system according to a first example embodiment.

FIG. 2 is a block diagram illustrating a functional configuration of the image generation system according to the first example embodiment.

FIG. 3 is a flowchart illustrating a flow of operation of the image generation system according to the first example embodiment.

FIG. 4 is a flowchart illustrating a flow of operation of an image generation system according to a second example embodiment.

FIG. 5 is a block diagram illustrating a functional configuration of an image generation system according to a third example embodiment.

FIG. 6 is a flowchart illustrating a flow of operation of the image generation system according to the third example embodiment.

FIG. 7 is a block diagram illustrating a functional configuration of an image generation system according to a fourth example embodiment.

FIG. 8 is a flowchart illustrating a flow of operation of the image generation system according to the fourth example embodiment.

FIG. 9 is a block diagram illustrating a functional configuration of an image generation system according to a fifth example embodiment.

FIG. 10 is a flowchart illustrating a flow of operation of the image generation system according to the fifth example embodiment.

FIG. 11 is a block diagram illustrating a functional configuration of an image generation system according to a sixth example embodiment.

FIG. 12 is a flowchart illustrating a flow of operation of the image generation system according to the sixth example embodiment.

FIG. 13 is a block diagram illustrating a functional configuration of an image generation system according to a seventh example embodiment.

FIG. 14 is a flowchart illustrating a flow of operation of the image generation system according to the seventh example embodiment.

FIG. 15 is a block diagram illustrating a functional configuration of an image generation system according to a modified example of the seventh example embodiment.

FIG. 16 is a flowchart illustrating a flow of operation of the image generation system according to the modified example of the seventh example embodiment.

FIG. 17 is a block diagram illustrating a functional configuration of an image generation system according to an eighth example embodiment.

FIG. 18 is a flowchart illustrating a flow of operation of the image generation system according to the eighth example embodiment.

FIG. 19 is a block diagram illustrating a functional configuration of an image generation system according to a modified example of the eighth example embodiment.

FIG. 20 is a flowchart illustrating a flow of operation of the image generation system according to the modified example of the eighth example embodiment.

FIG. 21 is a block diagram illustrating a functional configuration of an image generation system according to a ninth example embodiment.

FIG. 22 is a flowchart illustrating a flow of operation of the image generation system according to the ninth example embodiment.

### EXAMPLE EMBODIMENTS

Hereinafter, with reference to the drawings, an image generation system, an image generation method, and a recording medium according to example embodiments will be described.

### First Example Embodiment

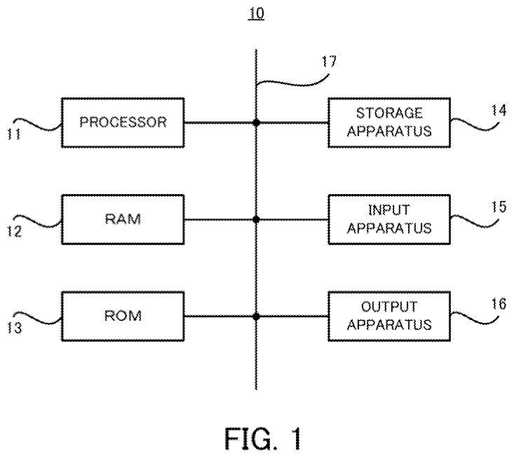

An image generation system according to a first example embodiment will be described with reference to FIG. 1 to FIG. 3.

### (Hardware Configuration)

First, with reference to FIG. 1, a hardware configuration of the image generation system according to the first example embodiment will be described. FIG. 1 is a block diagram illustrating the hardware configuration of the image generation system according to the first example embodiment.

As illustrated in FIG. 1, an image generation system 10 according to the first example embodiment includes a processor 11, a RAM (Random Access Memory) 12, a ROM (Read Only Memory) 13, and a storage apparatus 14. The image generation system 10 may further include an input apparatus 15 and an output apparatus 16. The processor 11, the RAM 12, the ROM 13, the storage apparatus 14, the input apparatus 15, and the output apparatus 16 are connected through a data bus 17.

The processor 11 reads a computer program. For example, the processor 11 is configured to read a computer program stored by at least one of the RAM 12, the ROM 13 and the storage apparatus 14. Alternatively, the processor 11 may read a computer program stored in a computer readable recording medium by using a not-illustrated recording medium reading apparatus. The processor 11 may obtain (i.e., may read) a computer program from a not-illustrated apparatus disposed outside the image generation system 10, through a network interface. The processor 11 controls the RAM 12, the storage apparatus 14, the input apparatus 15, and the output apparatus 16 by executing the read computer program. Especially in the example embodiment, when the processor 11 executes the read computer program, a functional block for generating a new image from an inputted image is realized or implemented in the processor 11. As the processor 11, one of a CPU (Central Processing Unit), a GPU (Graphics Processing Unit), a FPGA (field-programmable gate array), a DSP (Demand-Side Platform), and an ASIC (Application Specific Integrated Circuit) may be used, or a plurality of them may be used in parallel.

The RAM 12 temporarily stores the computer programs to be executed by the processor 11. The RAM 12 temporarily stores the data that is temporarily used by the processor 11 when the processor 11 executes the computer program. The RAM 12 may be, for example, a D-RAM (Dynamic RAM).

The ROM 13 stores the computer program to be executed by the processor 11. The ROM 13 may otherwise store fixed data. The ROM 13 may be, for example, a P-ROM (Programmable ROM).

The storage apparatus 14 stores the data that is stored for a long term by the image generation system 10. The storage apparatus 14 may operate as a temporary storage apparatus of the processor 11. The storage apparatus 14 may include, for example, at least one of a hard disk apparatus, a magneto-optical disk apparatus, a SSD (Solid State Drive), and a disk array apparatus.

The input apparatus 15 is an apparatus that receives an input instruction from a user of the image generation system 10. The input apparatus 15 may include, for example, at least one of a keyboard, a mouse, and a touch panel.

The output apparatus 16 is an apparatus that outputs information about the image generation system 10 to the outside. For example, the output apparatus 16 may be a display apparatus (e.g., a display) that is configured to display the information about the image generation system 10.

### (Functional Configuration)

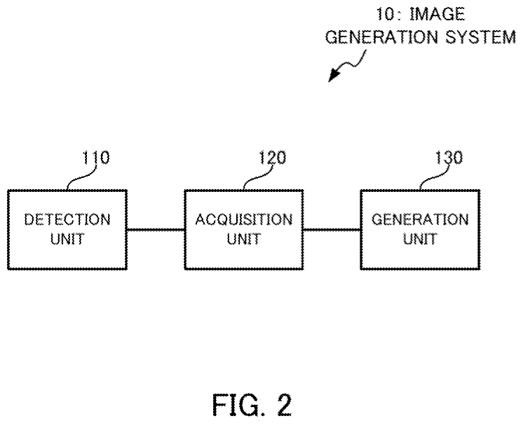

Next, with reference to FIG. 2, a functional configuration of the image generation system 10 according to the first example embodiment will be described. FIG. 2 is a block diagram illustrating the functional configuration of the image generation system according to the first example embodiment.

As illustrated in FIG. 2, the image generation system 10 according to the first example embodiment includes, as processing blocks or physical processing circuits for realizing its functions, a detection unit 110, an acquisition unit 120, and a generation unit 130. Each of the detection unit 110, the acquisition unit 120, and the generation unit 130 may be realized or implemented by the processor 11 (see FIG. 1), for example.

The detection unit 110 is configured to detect a position information about a position of a face, or a position of a feature point of the face, from an inputted image. The feature point of the face is a point representing a feature of the face, and is set to correspond to a particular part, such as eyes, ears, a nose, and a mouth, for example. Which part is set as the feature point may be set as appropriate, for example, by a system manager or the like. The detection unit 110 may detect both the position information about the position of the face and the position information about the position of the feature point of the face. In this case, the detection unit 110 may separately include a part for detecting the position information about the position of the face and a part for detecting the position information about the position of the feature point of the face (e.g., there may be configured two independent detection units 110). Furthermore, the detection unit 110 may be configured to firstly detect the position information about the position of the face and then detect the position information about the position of the feature point of the face on the basis of the detected position information about the position of the face. The position information may be, for example, a coordinate information or a vector information. The detection unit 110 may be configured, for example, as a neural network. A detailed description of a specific method of detecting the position information by the detection unit 110 will be omitted here, because the existing techniques/technologies can be adopted to the method as appropriate. The position information detected by the detection unit 110 is configured to be outputted to the acquisition unit 120.

The acquisition unit 120 is configured to obtain a perturbed position information that takes an error into account for the position information detected by the detection unit 110. The error here is an error that occurs when the position information is detected by the detection unit 110 (i.e., a detection error). In comparison with the position information detected by the detection unit 110, the perturbed position information has a perturbation corresponding to the error. When the error is considered for a plurality of feature points, the error may be added to all the feature points, or the error may be added only to a part of the feature points. When the error is added only to a part of the feature points, the feature point that takes the error into account may be automatically determined from a past history or the like, or may be specified by the user. A specific technique/technology that takes the error into account the position information will be described in detail in another example embodiment described later. The technique/technology that takes the error into account may be common to all the feature points, or may be different for each feature point. The perturbed position information obtained by the acquisition unit 120 is configured to be outputted to the generation unit 130.

The generation unit 130 is configured to generate a new image including the face on the basis of the perturbed position information obtained by the acquisition unit 120. The new image generated by the generation unit 130 is an image having a perturbation corresponding to the error, because it is generated on the basis the perturbed position information. Therefore, there is a difference corresponding to the error between the image inputted to the detection unit 110 and the new image generated by the generation unit 130. A detailed description of a specific method of generating the image from the position information will be omitted here, because the existing techniques/technologies can be adopted to the method as appropriate. The generation unit 130 has a function of outputting the generated new image. The generation unit 130 may be configured to output and display the generated new image on a display unit having a display, for example.

### (Flow of Operation)

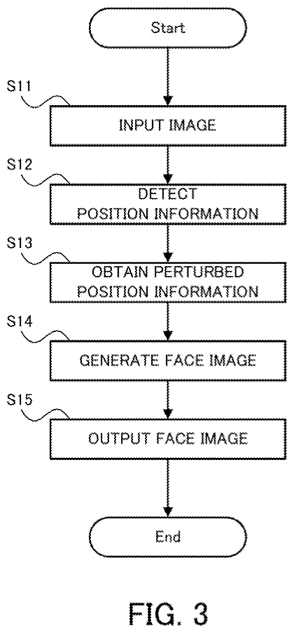

Next, with reference to FIG. 3, a flow of operation of the image generation system 10 according to the first example embodiment will be described. FIG. 3 is a flowchart illustrating the flow of the operation of the image generation system according to the first example embodiment.

As illustrated in FIG. 3, when the operation of the image generation system 10 according to the first example embodiment is started, first, an image is inputted to the detection unit 110 (step S11). When the image is inputted, the detection unit 110 detects the position information about the position of the face or the position of the feature point of the face from the image (step S12).

Subsequently, the acquisition unit 120 obtains the perturbed position information that takes the error into account for the position information (step S13). Then, the generation unit 130 generates a new image including the face on the basis of the perturbed position information (step S14). The generation unit 130 outputs the generated new image (step S15).

### (Technical Effect)

Next, a technical effect obtained by the image generation system 10 according to the first example embodiment will be described.

As described in FIG. 1 to FIG. 3, in the image generation system 10 according to the first example embodiment, a new face image is generated on the basis of the perturbed position information that takes into account the error in the detection. Therefore, it is possible to generate a new face image including a variation in position corresponding to the error, from the inputted image.

### Second Example Embodiment

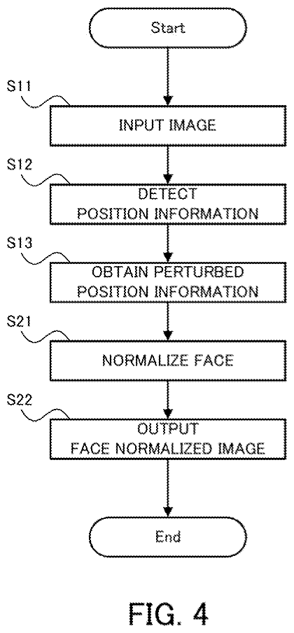

The image generation system 10 according to a second example embodiment will be described with reference to FIG. 4. The second example embodiment is partially different from the first example embodiment only in the operation, and may be the same as the first example embodiment in the system configuration or the like (see FIG. 1 and FIG. 2). For this reason, the parts that differ from the first example embodiment will be described in detail below, and a description of the other overlapping parts will be omitted as appropriate.

### (Flow of Operation)

First, with reference to FIG. 4, a flow of operation of the image generation system 10 according to the second example embodiment will be described. FIG. 4 is a flowchart illustrating the flow of the operation of the image generation system according to the second example embodiment. In FIG. 4, the same steps as those illustrated in FIG. 3 carry the same reference numerals.

As illustrated in FIG. 4, when the operation of the image generation system 10 according to the second example embodiment is started, first, an image is inputted to the detection unit 110 (the step S11). When the image is inputted, the detection unit 110 detects the position information about the position of the face or the position of the feature point of the face from the image (the step S12).

Subsequently, the acquisition unit 120 obtains the perturbed position information that takes the error into account for the position information (the step S13). Then, the generation unit 130 performs a process of normalizing the face on the basis of the perturbed position information (step S21). The generation unit 130 outputs a face normalized image that is an image including the normalized face, as a new image (step S22).

### (Face Normalization)

Next, the process of normalizing the face performed by the image generation system 10 according to the second example embodiment will be described, more specifically.

The face normalization is realized by adjusting at least one of the position, size and angle of the face on the basis of the position information. The face normalization is realized by properly adjusting the position, size, and angle of the face such that the feature point of the face, such as eyes, a nose, and a mouth, is at a predetermined position. The face normalization may use an imaging processing technique/technology, such as image enlargement and reduction, rotation, and 2D/3D conversion. Existing techniques/technologies that are not mentioned here may be adopted to the face normalization, as appropriate.

### (Technical Effect)

Next, a technical effect obtained by the image generation system 10 according to the second example embodiment will be described.

As described in FIG. 4, in the image generation system 10 according to the second example embodiment, the face normalized image is generated as the new image. Especially in the example embodiment, the face is normalized on the basis of the perturbed position information. Thus, it is possible to generate a normalized image including a variation in position corresponding to the error.

In the following example embodiments, as in the second example embodiment, a description will be made by exemplifying the configuration in which the generation unit 130 generates the face normalized image.

### Third Example Embodiment

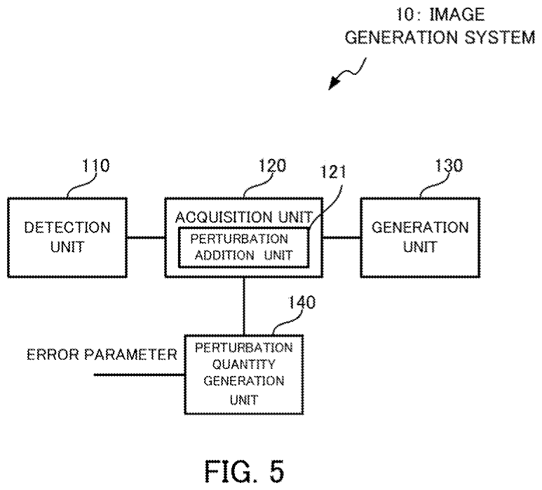

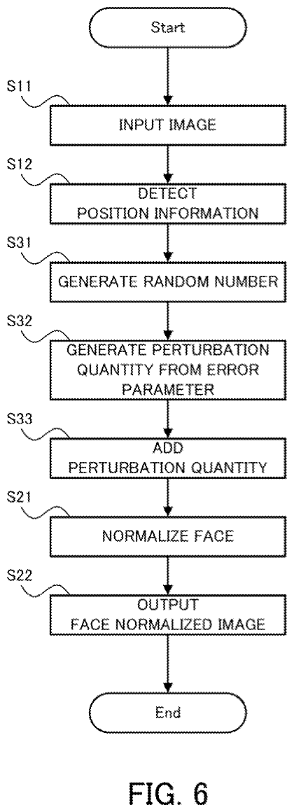

The image generation system 10 according to a third example embodiment will be described with reference to FIG. 5 and FIG. 6. The third example embodiment is partially different from the first and second example embodiments only in the configuration and operation, and may be the same as the first and second example embodiments in other parts. For this reason, the parts that differ from the first and second example embodiments will be described in detail below, and a description of the other overlapping parts will be omitted as appropriate.

### (Functional Configuration)

First, with reference to FIG. 5, a functional configuration of the image generation system 10 according to the third example embodiment will be described. FIG. 5 is a block diagram illustrating the functional configuration of the image generation system according to the third example embodiment. In FIG. 5, the same components as those illustrated in FIG. 2 carry the same reference numerals.

As illustrated in FIG. 5, the image generation system 10 according to the third example embodiment includes, as processing blocks or physical processing circuits for realizing its functions, the detection unit 110, the acquisition unit 120, the generation unit 130, and a perturbation quantity generation unit 140. That is, the image generation system 10 according to the third example embodiment further includes a perturbation quantity generation unit 140 in addition to the configuration in the first example embodiment (see FIG. 2). The perturbation quantity generating 140 may be realized or implemented by the processor 11 (see FIG. 1).

The perturbation quantity generation unit 140 is configured to generate a perturbation quantity in accordance with an error parameter (i.e., a value indicating the magnitude of the error). The perturbation quantity generation unit 140 may generate the perturbation quantity, for example, by multiplying the error parameter by a predetermined random number. The random number in this case may be generated by using a random number generator or the like that uses a normal distribution (e.g., a normal distribution with a mean of 0 and a variance of 1). The error parameter may be a value specified by the user. The perturbation quantity generated by the perturbation quantity generation unit 140 is configured to be outputted to a perturbation addition unit 121 of the acquisition unit 120.

The perturbation addition unit 121 is configured to perform a process of adding the perturbation quantity to a parameter (i.e., the position information) indicating the position of the face or the position of the feature point of the face detected by the detection unit 110. The perturbation addition unit 121 may perform a process of adding the perturbation quantity as it is, or may perform a process of adding it after multiplying the perturbation quantity by a predetermined factor. The acquisition unit 120 obtains a result of the addition process by the perturbation addition unit 121, as the perturbed position information.

### (Flow of Operation)

Next, a flow of operation of the image generation system 10 according to the third example embodiment will be described with reference to FIG. 6. FIG. 6 is a flowchart illustrating the flow of the operation of the image generation system according to the third example embodiment. In FIG. 6, the same steps as those illustrated in FIG. 3 and FIG. 4 carry the same reference numerals.

As illustrated in FIG. 6, when the operation of the image generation system 10 according to the third example embodiment is started, first, an image is inputted to the detection unit 110 (the step S11). When the image is inputted, the detection unit 110 detects the position information about the position of the face or the position of the feature point of the face from the image (the step S12).

Subsequently, the perturbation quantity generation unit 140 generates the random number for generating the perturbation quantity (step S31). Then, the perturbation quantity generation unit 140 generates the perturbation quantity from the generated random number and the error parameter (step S32).

Subsequently, the perturbation addition unit 121 adds the perturbation quantity to the position information detected by the detection unit 110, and obtains the perturbed position information (step S33). Then, the generation unit 130 performs the process of normalizing the face on the basis of the perturbed position information (the step S21). The generation unit 130 outputs the face normalized image that is an image including the normalized face, as a new image (the step S22).

### (Technical Effect)

Next, a technical effect obtained by the image generation system 10 according to the third example embodiment will be described.

As described in FIG. 5 and FIG. 6, in the image generation system 10 according to the third example embodiment, the perturbation quantity is generated on the basis of the error parameter. Then, the perturbation quantity is added to the detected position information, thereby to obtain the perturbed position information. In this way, it is possible to properly obtain the perturbed position information that takes the error into account. Therefore, it is possible to properly generate a new face image including a variation in position corresponding to the error, from the inputted image.

### Fourth Example Embodiment

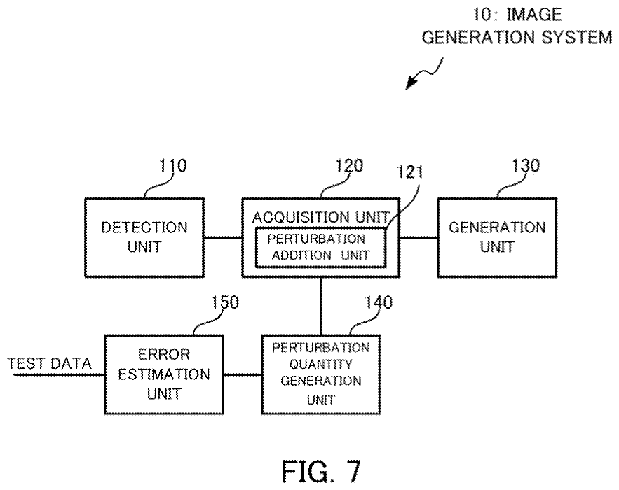

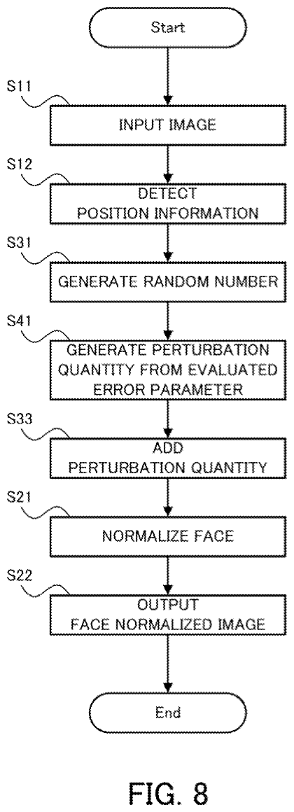

The image generation system 10 according to a fourth example embodiment will be described with reference to FIG. 7 and FIG. 8. The fourth example embodiment is partially different from the first to third example embodiments only in the configuration and operation, and may be the same as the first to third example embodiments in other parts. For this reason, the parts that differ from the first to third example embodiments will be described in detail below, and a description of the other overlapping parts will be omitted as appropriate.

### (Functional Configuration)

First, with reference to FIG. 7, a functional configuration of the image generation system 10 according to the fourth example embodiment will be described. FIG. 7 is a block diagram illustrating the functional configuration of the image generation system according to the fourth example embodiment. In FIG. 7, the same components as those illustrated in FIG. 2 and FIG. 5 carry the same reference numerals.

As illustrated in FIG. 7, the image generation system 10 according to the fourth example embodiment includes, as processing blocks or physical processing circuits for realizing its functions, the detection unit 110, the acquisition unit 120, the generation unit 130, the perturbation quantity generation unit 140, and an error evaluation unit 150. That is, the image generation system 10 according to the fourth example embodiment further includes an error evaluation unit 150 in addition to the configuration in the third example embodiment (see FIG. 5). The error evaluation unit 150 may be realized or implemented by the processor 11 (see FIG. 1).

The error evaluation unit 150 is configured to evaluate an error by using test data for error evaluation (i.e., to estimate the error that occurs when the position information is detected). The test data are data having correct answer data about the position information. The error evaluation unit 150 may evaluate the error by a statistical method on the basis of a deviation amount between the position information detected from the test data and the correct answer data. Existing techniques/technologies can be properly adopted to a specific method of evaluating the error, but an example of the specific method may include MAE (Mean Absolute Error). An evaluation result of the error evaluation unit 150 is configured to be outputted to the perturbation quantity generation unit 140 as the error parameter. That is, in this example embodiment, the perturbation quantity is generated on the basis of the error parameter evaluated by the error evaluation unit 150.

### (Flow of Operation)

Next, a flow of operation of the image generation system 10 according to the fourth example embodiment will be described with reference to FIG. 8. FIG. 8 is a flowchart illustrating the flow of the operation of the image generation system according to the fourth example embodiment. In FIG. 8, the same steps as those illustrated in FIG. 3, FIG. 4, and FIG. 6 carry the same reference numerals.

As illustrated in FIG. 8, when the operation of the image generation system 10 according to the fourth example embodiment is started, first, an image is inputted to the detection unit 110 (the step S11). When the image is inputted, the detection unit 110 detects the position information about the position of the face or the position of the feature point of the face from the image (the step S12).

Subsequently, the perturbation quantity generation unit 140 generates the random number for generating the perturbation quantity (the step S31). Then, the perturbation quantity generation unit 140 generates the perturbation quantity from the generated random number and the error parameter evaluated by the error evaluation unit 150 (step S41). The error evaluation by the error evaluation unit 150 may be performed separately before the start of a series of processing steps illustrated in FIG. 8. The error evaluation by the error evaluation unit 150, however, may be performed after the start of a series of processing steps illustrated in FIG. 8 and before the step S41.

Subsequently, the perturbation addition unit 121 adds the perturbation quantity to the position information detected by the detection unit 110, and obtains the perturbed position information (the step S33). Then, the generation unit 130 performs the process of normalizing the face on the basis of the perturbed position information (the step S21). The generation unit 130 outputs the face normalized image that is an image including the normalized face, as a new image (the step S22).

### (Technical Effect)

Next, a technical effect obtained by the image generation system 10 according to the fourth example embodiment will be described.

As described in FIG. 7 and FIG. 8, in the image generation system 10 according to the fourth example embodiment, the perturbation quantity is generated on the basis of the error parameter that is the result of the error evaluation using the test data. Then, the perturbed position information is obtained by adding the perturbation quantity to the detected position information. In this way, it is possible to properly obtain the perturbed position information that takes the error into account. Therefore, it is possible to properly generate a new face image including a variation in position corresponding to the error, from the inputted image.

The third example embodiment and the fourth example embodiment may be combined with each other. For example, both the error parameter specified by the user and the error parameter outputted from the error evaluation unit 150 may be integrated into an integrated error parameter, from which the perturbation quantity may be generated. The integrated error parameter may be a mean value of error parameters, for example. Furthermore, the error parameter specified by the user and the error parameter outputted from the error evaluation unit 150 may be selectively utilized. That is, out of the perturbation quantity generated from the error parameter specified by the user and the perturbation quantity generated from the error parameter outputted from the error evaluation unit 150, the selected one of them may be added to obtain the perturbed position information. In this case, the selection of the perturbation quantity may be performed automatically by the system, or by the user.

### Fifth Example Embodiment

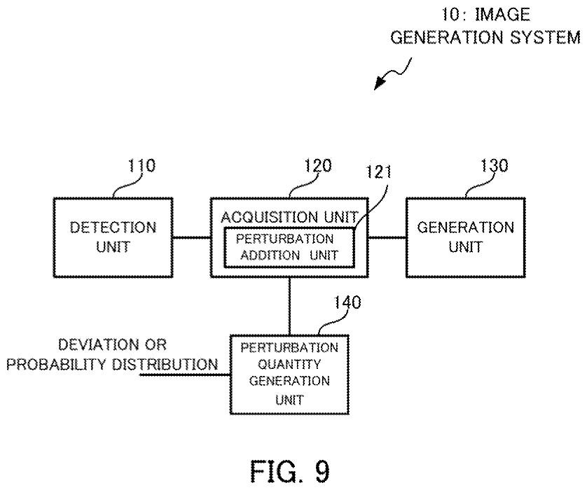

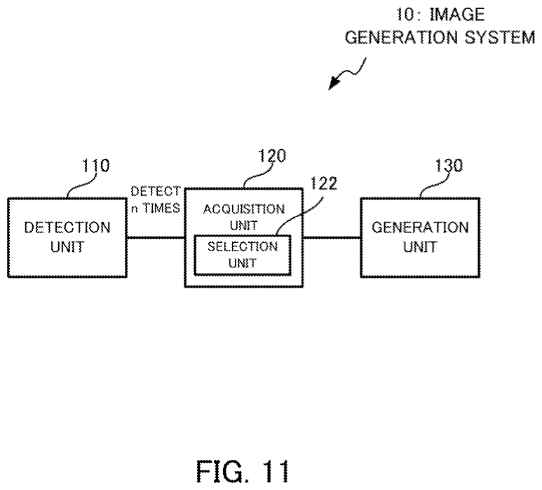

The image generation system 10 according to a fifth example embodiment will be described with reference to FIG. 9 and FIG. 11. The fifth example embodiment is partially different from the first to fourth example embodiments only in the configuration and operation, and may be the same as the first to fourth example embodiments in other parts. For this reason, the parts that differ from the first to fourth example embodiments will be described in detail below, and a description of the other overlapping parts will be omitted as appropriate.

### (Functional Configuration)

First, with reference to FIG. 9, a functional configuration of the image generation system 10 according to the fifth example embodiment will be described. FIG. 9 is a block diagram illustrating the functional configuration of the image generation system according to the fifth example embodiment. In FIG. 9, the same components as those illustrated in FIG. 5 and FIG. 7 carry the same reference numerals.

As illustrated in FIG. 9, the image generation system 10 according to the fifth example embodiment includes, as processing blocks or physical processing circuits for realizing its functions, the detection unit 110, the acquisition unit 120, the generation unit 130, and the perturbation quantity generation unit 140. That is, the image generation system 10 according to the fifth example embodiment includes the same components as those in the configuration in the third example embodiment (see FIG. 5). The perturbation quantity generation unit 140 according to the fifth example embodiment, however, is configured such that a deviation of a probability distribution is inputted thereto. The deviation of the probability distribution may be, for example, a deviation of a Gaussian distribution. The perturbation quantity generation unit 140 is configured to generate the perturbation quantity on the basis of the inputted deviation of the probability distribution. For example, the perturbation quantity generation unit 140 may generate the perturbation quantity by multiplying the deviation of the probability distribution by the random number.

### (Flow of Operation)

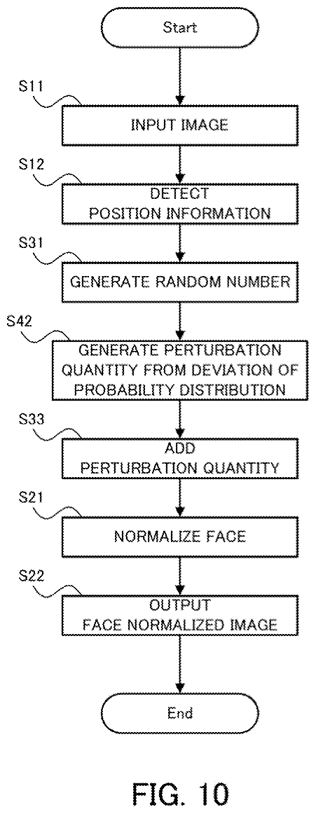

Next, a flow of operation of the image generation system 10 according to the fifth example embodiment will be described with reference to FIG. 10. FIG. 10 is a flowchart illustrating the flow of the operation of the image generation system according to the fifth example embodiment. In FIG. 10, the same steps as those illustrated in FIG. 6 and FIG. 8 carry the same reference numerals.

As illustrated in FIG. 10, when the operation of the image generation system 10 according to the fifth example embodiment is started, first, an image is inputted to the detection unit 110 (the step S11). When the image is inputted, the detection unit 110 detects the position information about the position of the face or the position of the feature point of the face from the image (the step S12).

Subsequently, the perturbation quantity generation unit 140 generates the random number for generating the perturbation quantity (the step S31). Then, the perturbation quantity generation unit 140 generates the perturbation quantity from the generated random number and the deviation of the probability distribution (step S42).

Subsequently, the perturbation addition unit 121 adds the perturbation quantity to the position information detected by the detection unit 110 (the step S33), and obtains the perturbed position information. Then, the generation unit 130 performs the process of normalizing the face on the basis of the perturbed position information (the step S21). The generation unit 130 outputs the face normalized image that is an image including the normalized face, as a new image (the step S22).

### (Technical Effect)

Next, a technical effect obtained by the image generation system 10 according to the fifth example embodiment will be described.

As described in FIG. 9 and FIG. 10, in the image generation system 10 according to the fifth example embodiment, the perturbation quantity is generated on the basis of the deviation of the probability distribution. Then, the perturbed position information is obtained by adding the perturbation quantity to the detected position information. In this way, it is possible to properly obtain the perturbed position information that takes the error into account. Therefore, it is possible to properly generate a new face image including a variation in position corresponding to the error, from the inputted image.

### Sixth Example Embodiment

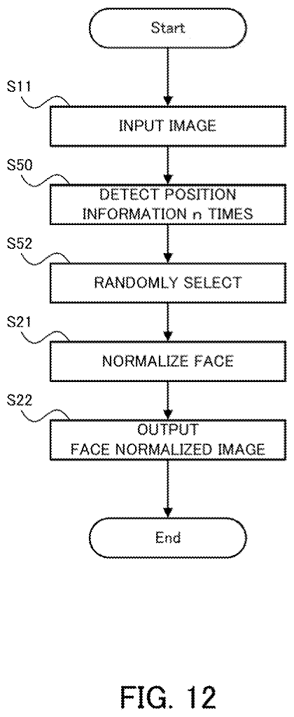

The image generation system 10 according to the sixth example embodiment will be described with reference to FIG. 11 and FIG. 12. The sixth example embodiment is partially different from the first to fifth example embodiments only in the configuration and operation, and may be the same as the first to fifth example embodiments in other parts. For this reason, the parts that differ from the first to fifth example embodiments will be described in detail below, and a description of the other overlapping parts will be omitted as appropriate.

### (Functional Configuration)

First, with reference to FIG. 11, a functional configuration of the image generation system according to the sixth example embodiment will be described. FIG. 11 is a block diagram illustrating the functional configuration of the image generation system according to the sixth example embodiment. In FIG. 11, the same components as those illustrated in FIG. 2 carry the same reference numerals.

As illustrated in FIG. 11, the image generation system 10 according to the sixth example embodiment includes, as processing blocks or physical processing circuits for realizing its functions, the detection unit 110, the acquisition unit 120, and the generation unit 130. The detection unit 110 according to the sixth example embodiment, however, is configured to perform n times of detections (n is a natural number) in a predetermined period (within a predetermined time, when a predetermined operation is performed, from when a predetermined first operation is performed to when a predetermined second operation is performed, etc.) and to output n position informations. The n position informations may be outputted sequentially, or may be outputted collectively.

Each of then position informations detected by the detection unit 110 is configured to be outputted to the acquisition unit 120. In particular, the acquisition unit 120 according to the sixth example embodiment is configured to include a selection unit 122. The selection unit 122 is configured to randomly select one position information from the n position informations detected by the detection unit 110. Since the n position informations are respectively detected at different times, they are informations having errors for each other as a whole. Therefore, the position information randomly selected from the n position informations may be used as the perturbed position information that takes the error into account. The acquisition unit 120 is configured to output the position information selected by the selection unit 122 to the generation unit 130, as the perturbed position information.

### (Flow of Operation)

Next, a flow of operation of the image generation system 10 according to the sixth example embodiment will be described with reference to FIG. 12. FIG. 12 is a flowchart illustrating the flow of the operation of the image generation system according to the sixth example embodiment. In FIG. 12, the same steps as those illustrated in FIG. 3 and FIG. 4 carry the same reference numerals.

As illustrated in FIG. 12, when the operation of the image generation system 10 according to the sixth example embodiment is started, first, an image is inputted to the detection unit 110 (the step S11). When the image is inputted, the detection unit 110 detects, n times, the position information about the position of the face or the position of the feature point of the face from the image (step S50). As a result, n position informations are detected from the detection unit 110.

Subsequently, the selection unit 122 randomly selects one position information from the n position informations (step S52). Then, the generation unit 130 performs the process of normalizing the face on the basis of the randomly selected position information (i.e., the perturbed position information) (the step S21). The generation unit 130 outputs the face normalized image that is an image including the normalized face, as a new image (the step S22).

### (Technical Effect)

Next, a technical effect obtained by the image generation system 10 according to the sixth example embodiment will be described.

As described in FIG. 11 and FIG. 12, in the image generation system 10 according to the sixth example embodiment, the n position informations are detected by the detection unit 110. Then, the position information randomly selected from the n position informations is used as the perturbed position information for generating a new image. In this way, it is possible to obtain the perturbed position information without directly calculating the error (e.g., without adding the perturbation quantity, unlike in the third example embodiment to the fifth example embodiment). Therefore, it is possible to properly generate a new face image including a variation in position corresponding to the error.

### Seventh Example Embodiment

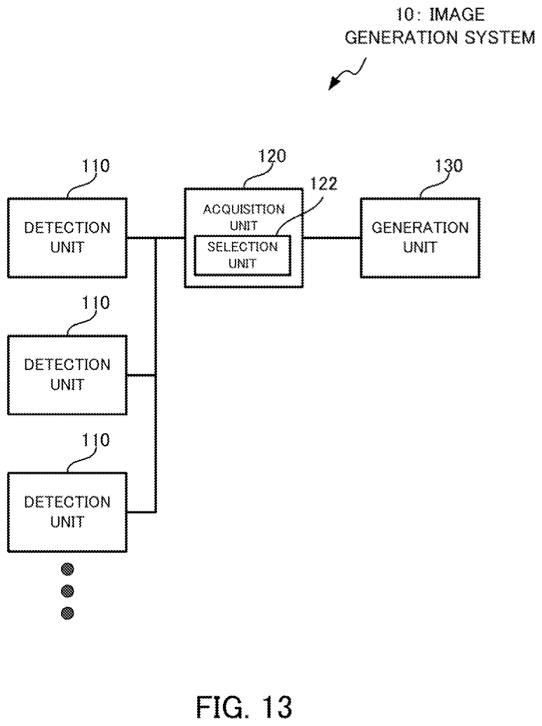

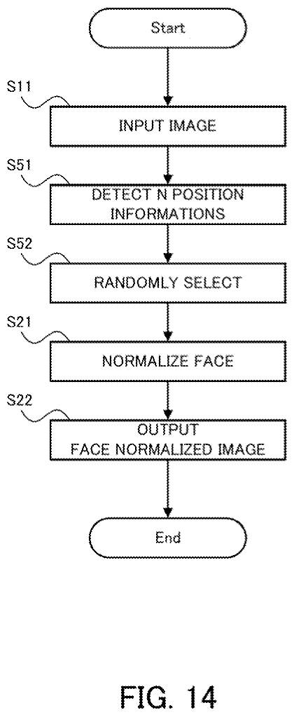

The image generation system 10 according to a seventh example embodiment will be described with reference to FIG. 13 and FIG. 14. The seventh example embodiment is partially different from the first to sixth example embodiments only in the configuration and operation, and may be the same as the first to sixth example embodiments in other parts. For this reason, the parts that differ from the first to sixth example embodiments will be described in detail below, and a description of the other overlapping parts will be omitted as appropriate.

### (Functional Configuration)

First, with reference to FIG. 13, a functional configuration of the image generation system according to the seventh example embodiment will be described. FIG. 13 is a block diagram illustrating the functional configuration of the image generation system according to the seventh example embodiment. In FIG. 13, the same components as those illustrated in FIG. 2 and FIG. 11 carry the same reference numerals.

As illustrated in FIG. 13, the image generation system 10 according to the seventh example embodiment includes, as processing blocks or physical processing circuits for realizing its functions, a plurality of detection units 110, the acquisition unit 120, and the generation unit 130. That is, the image generation system 10 according to the seventh example embodiment is different from that according to the sixth example embodiment (see FIG. 11) in that it includes a plurality of independent detection units 110 in the configuration. In FIG. 13, three detection units 110 are illustrated for convenience, but the image generation system 10 according to the seventh example embodiment may include three or more detection units 110. In the following, a description will be made on the assumption that the image generation system 10 according to the seventh example embodiment includes N detection units 110 (N is a natural number).

Each of the position informations detected by the N detection units 110 is configured to be outputted to the acquisition unit 120. In particular, the acquisition unit 120 according to the seventh example embodiment includes the selection unit 122. The selection unit 122 is configured to randomly select one position information from N position informations detected by the N detection unit 110. When N detection units 110 perform n times of detections as in the sixth example embodiment, the selection unit 122 may randomly select one position information from N×n position informations. Since the N position informations are detected by the respective different detection units 110, they are informations having errors for each other as a whole. Therefore, the position information randomly selected from the N position informations detected by the separate detection unit 110 may be used as the perturbed position information that takes the error into account. The acquisition unit 120 is configured to output the position information selected by selection unit 122 to the generation unit 130, as the perturbed position information.

### (Flow of Operation)

Next, a flow of operation of the image generation system 10 according to the seventh example embodiment will be described with reference to FIG. 14. FIG. 14 is a flowchart illustrating the flow of the operation of the image generation system according to the seventh example embodiment. In FIG. 14, the same steps as those illustrated in FIG. 3 and FIG. 4 carry the same reference numerals.

As illustrated in FIG. 14, when the operation of the image generation system 10 according to the seventh example embodiment is started, first, an image is inputted to each of the N detection units 110 (the step S11). When the image is inputted, each of the N detection units 110 detects the position information about the position of the face or the position of the feature point of the face from the image (step S51). As a result, N position informations are detected.

Subsequently, the selection unit 122 randomly selects one position information from the N position informations (step S52). Then, the generation unit 130 performs the process of normalizing the face on the basis of the randomly selected position information (i.e., the perturbed position information) (the step S21). The generation unit 130 outputs the face normalized image that is an image including the normalized face, as a new image (the step S22).

### (Technical Effect)

Next, a technical effect obtained by the image generation system 10 according to the seventh example embodiment will be described.

As described in FIG. 13 and FIG. 14, in the image generation system 10 according to the seventh example embodiment, the N position informations are detected by the N independent detection units 110. Then, the position information randomly selected from the N position informations is used as the perturbed position information for generating a new image. In this way, it is possible to obtain the perturbed position information without directly calculating the error (e.g., without adding the perturbation quantity, unlike in the third example embodiment to the fifth example embodiment). Therefore, it is possible to properly generate a new face image including a variation in position corresponding to the error.

### (Modified Example of Seventh Example Embodiment)

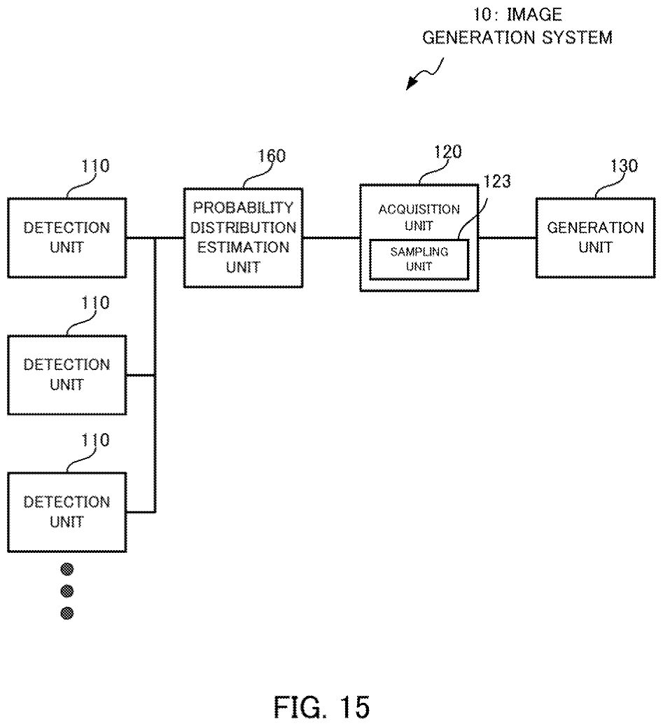

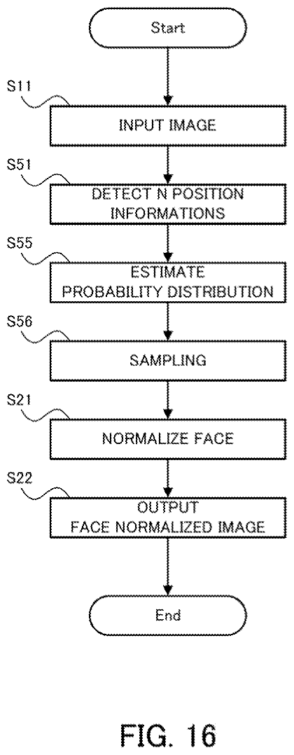

Next, the image generation system 10 according to a modified example of the seventh example embodiment will be described with reference to FIG. 15 and FIG. 16. The image generation system 10 according to the modified example of the seventh example embodiment is partially different from the seventh example embodiment only in the operation, and may be the same as the seventh example embodiment in the other operations and system configurations. For this reason, the parts that differ from the seventh example embodiment will be described in detail below, and a description of the other overlapping parts will be omitted as appropriate.

### (Functional Configuration)

First, with reference to FIG. 15, a functional configuration of the image generation system 10 according to the modified example of the seventh example embodiment will be described. FIG. 15 is a block diagram illustrating the functional configuration of the image generation system according to the modified example of the fifth example embodiment. In FIG. 15, the same components as those illustrated in FIG. 13 carry the same reference numerals.

As illustrated in FIG. 15, the image generation system 10 according to the modified example of the seventh example embodiment includes, as processing blocks for realizing its functions, a plurality of detection units 110, the acquisition unit 120, the generation unit 130, and a probability distribution estimation unit 160. That is, the image generation system 10 according to the modified example of the seventh example embodiment further includes a probability distribution estimation unit 160 in addition to the configuration in the seventh example embodiment (see FIG. 13). The probability distribution estimation unit 160 may be realized or implemented by the processor 11 (see FIG. 1).

The probability distribution estimation unit 160 is configured to perform a process of fitting a predetermined probability distribution to the N position informations detected by the N detection units 110. The probability distribution estimation unit 160 may fit a Gaussian distribution to the N position informations, for example. In this case, the position information may be a value that is expressed by an equation of Gaussian model mean+Gaussian model deviation×random number.

A result of the fitting process of the probability distribution estimation unit 160 is configured to be outputted to the acquisition unit 120. In particular, the acquisition unit 120 according to the modified example of the seventh example embodiment includes a sampling unit 123. The sampling unit 123 is configured to sample one position information from the probability distribution that is outputted as the processing result of the probability distribution estimation unit 160. The position information sampled in this way may be used as the perturbed position information that takes the error into account. The acquisition unit 120 is configured to output the position information sampled by the sampling unit 123 to the generation unit 130, as the perturbed position information.

### (Flow of Operation)

Next, a flow of operation of the image generation system 10 according to the modified example of the seventh example embodiment will be described with reference to FIG. 16. FIG. 16 is a flowchart illustrating a flow of operation of the image generation system according to the modified example of the seventh example embodiment. In FIG. 16, the same steps as those illustrated in FIG. 13 carry the same reference numerals.

As illustrated in FIG. 16, when the operation of the image generation system 10 according to the modified example of the seventh example embodiment is started, first, an image is inputted to each of the N detection units 110 (the step S11). When the image is inputted, each of the N detection units 110 detects the position information about the position of the face or the position of the feature point of the face from the image (the step S51). As a result, N position informations are detected.

Subsequently, the probability distribution estimation unit 160 performs the process of fitting the predetermined probability distribution to the N position informations(step S55). Then, the sampling unit 123 samples one position information from the probability distribution that is outputted as the processing result of the probability distribution estimation unit 160 (step S56).

Then, the generation unit 130 performs the process of normalizing the face on the basis of the sampled position information (i.e., the perturbed position information) (the step S21). The generation unit 130 outputs the face normalized image that is an image including the normalized face, as a new image (the step S22).

### (Technical Effect)

Next, a technical effect obtained by the image generation system 10 according to the modified example of the seventh example embodiment will be described.

As described in FIG. 15 and FIG. 16, in the image generation system 10 according to the modified example of the seventh example embodiment, the N position informations are detected by the N independent detection units 110. Then, the probability distribution is fitted to the N position informations, and the position information sampled from the distribution is used as the perturbed position information for generating a new image. In this way, it is possible to obtain the perturbed position information from the probability distribution estimated from the N position informations. Therefore, it is possible to properly generate a new face image including a variation in position corresponding to the error.

### Eighth Example Embodiment

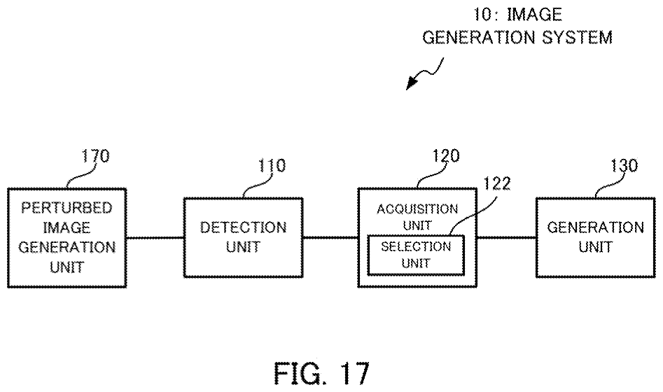

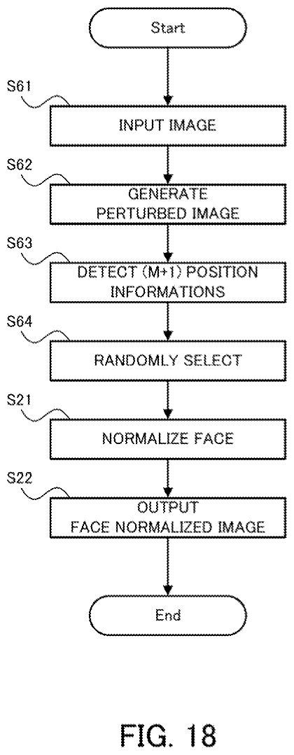

The image generation system 10 according to an eighth example embodiment will be described with reference to FIG. 17 and FIG. 18. The eighth example embodiment is partially different from the first to seventh example embodiments only in the configuration and operation, and may be the same as the first to seventh example embodiments in other parts. For this reason, the parts that differ from the first to seventh example embodiments will be described in detail below, and a description of the other overlapping parts will be omitted as appropriate.

### (Functional Configuration)

First, with reference to FIG. 17, a functional configuration of the image generation system according to the eighth example embodiment will be described. FIG. 17 is a block diagram illustrating the functional configuration of the image generation system according to the eighth example embodiment. In FIG. 17, the same components as those illustrated in FIG. 2 and FIG. 13 carry the same reference numerals.

As illustrated in FIG. 17, the image generation system 10 according to the eighth example embodiment includes, as processing blocks for realizing its functions, the detection unit 110, the acquisition unit 120, the generation unit 130, and a perturbed image generation unit 170. That is, the image generation system 10 according to the eighth example embodiment further includes a perturbed image generation unit 170 in addition to the configuration in the first example embodiment (see FIG. 2). The perturbed image generation unit 170 may be realized or implemented by the processor 11 (see FIG. 1).

The perturbed image generation unit 170 is configured to generate a plurality of perturbed images by perturbating the inputted image. The perturbed image generation unit 170 is configured to apply the perturbation by such processes as, for example, segmenting, reducing and enlarging, rotating, inverting, and changing a color tone of the image. The number of perturbed images generated by the perturbed image generation unit 170 may be fixed, or may be variable. In the following, a description will be made on the assumption that the perturbed image generation unit 170 generates M perturbed images (M is a natural number). When the perturbed image generation unit 170 generates M perturbed images, one original image and the M perturbed image, i.e., a total of (M+1) images are outputted from the perturbed image generation unit 170.

The (M+1) images outputted from the perturbed image generation unit 170 is configured to be outputted to the detection unit 110. Therefore, (M+1) position informations are outputted (detected?) from the detection unit 110 according to the eighth example embodiment.

Each of the (M+1) position informations detected by the detection unit 110 is configured to be outputted to the acquisition unit 120. In particular, the acquisition unit 120 according to the eighth example embodiment includes the selection unit 122. The selection unit 122 is configured to randomly select one position information from the (M+1) position informations. Since the (M+1) position informations are detected from the respective different images (i.e., the perturbed images), they are informations having errors for each other as a whole. Therefore, the position information randomly selected from the (M+1) position informations may be used as the perturbed position information that takes the error into account. The acquisition unit 120 is configured to output the position information selected by the selection unit 122 to the generation unit 130, as the perturbed position information.

### (Flow of Operation)

Next, a flow of operation of the image generation system 10 according to the eighth example embodiment will be described with reference to FIG. 18. FIG. 18 is a flowchart illustrating the flow of the operation of the image generation system according to the eighth example embodiment. In FIG. 18, the same steps as those illustrated in FIG. 3, FIG. 4 and FIG. 14 carry the same reference numerals.

As illustrated in FIG. 18, when the operation of the image generation system 10 according to the eighth example embodiment is started, first, an image is inputted to the perturbed image generation unit 170 (step S61). When the image is inputted, the perturbed image generation unit 170 generates M perturbed images from the image (step 62).

Subsequently, the detection unit 110 detects the position informations about the position of the face or the position of the feature point of the face, respectively, from (M+1) images (i.e., one original image+M perturbed images) (step S63). As a result, (M+1) position informations are detected.

Subsequently, the selection unit 122 randomly selects one position information from the (M+1) position informations (step S64). Then, the generation unit 130 performs the process of normalizing the face on the basis of the randomly selected position information (i.e., the perturbed position information) (the step S21). The generation unit 130 outputs the face normalized image that is an image including the normalized face, as a new image (the step S22).

### (Technical Effect)

Next, a technical effect obtained by the image generation system 10 according to the eighth example embodiment will be described.

As described in FIG. 17 and FIG. 18, in the image generation system 10 according to the eighth example embodiment, since the M perturbed images are generated from the inputted image, the (M+1) position informations are detected. Then, the position information randomly selected from the (M+1) position informations is used as the perturbed position information for generating a new image. In this way, it is possible to obtain the perturbed position information without directly calculating the error (e.g., without adding the perturbation quantity, unlike in the third example embodiment and the fourth example embodiment). Therefore, it is possible to properly generate a new face image including a variation in position corresponding to the error, from the inputted image.

### (Modified Example of Eighth Example Embodiment)

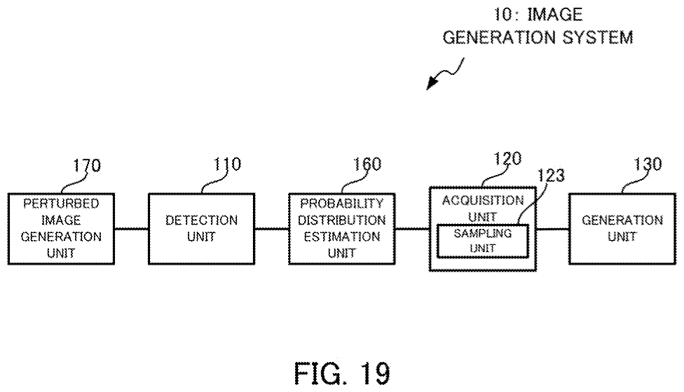

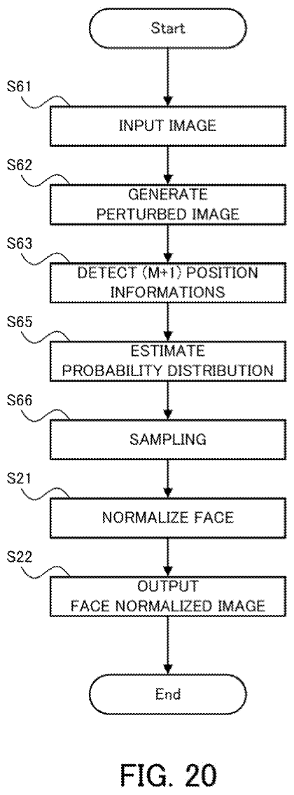

Next, the image generation system 10 according to a modified example of the eighth example embodiment will be described with reference to FIG. 19 and FIG. 20. The image generation system 10 according to the modified example of the eighth example embodiment is partially different from the eighth example embodiment only in the operation, and may be the same as the eighth example embodiment in the other operations and system configuration. For this reason, the parts that differ from the eighth example embodiment will be described in detail below, and a description of the other overlapping parts will be omitted as appropriate.

### (Functional Configuration)

First, with reference to FIG. 19, a functional configuration of the image generation system according to the modified example of the eighth example embodiment will be described. FIG. 19 is a block diagram illustrating the functional configuration of the image generation system according to the modified example of the eighth example embodiment. In FIG. 19, the same components as those illustrated in FIG. 17 carry the same reference numerals.

As illustrated in FIG. 19, the image generation system 10 according to the modified example of the eighth example embodiment includes, as processing blocks for realizing its functions, the detection unit 110, the acquisition unit 120, the generation unit 130, the probability distribution estimation unit 160, and the perturbed image generation unit 170. That is, the image generation system 10 according to the modified example of the eighth example embodiment further includes the probability distribution estimation unit 160 in addition to the configuration in the eighth example embodiment (see FIG. 17). The probability distribution estimation unit 160 may be realized or implemented by the processor 11 (see FIG. 1).

The probability distribution estimation unit 160 is configured to perform a process of fitting a predetermined probability distribution to the (M+1) position informations detected from the (M+1) images. The probability distribution estimation unit 160 may fit a Gaussian distribution to the N position informations, for example. In this case, the position information may be a value that is expressed by an equation of Gaussian model mean+Gaussian model deviation×random number.

A result of the fitting process of the probability distribution estimation unit 160 is configured to be outputted to the acquisition unit 120. In particular, the acquisition unit 120 according to the modified example of the eighth example embodiment includes the sampling unit 123. The sampling unit 123 is configured to sample one position information from the probability distribution that is outputted as the processing result of the probability distribution estimation unit 160. The position information sampled in this way may be used as the perturbed position information that takes the error into account. The acquisition unit 120 is configured to output the position information sampled by the sampling unit 123 to the generation unit 130, as the perturbed position information.

### (Flow of Operation)

Next, a flow of operation of the image generation system 10 according to the modified example of the eighth example embodiment will be described with reference to FIG. 20. FIG. 20 is a flowchart illustrating the flow of the operation of the image generation system according to the modified example of the eighth example embodiment. In FIG. 20, the same steps as those illustrated in FIG. 18 carry the same reference numerals.

As illustrated in FIG. 20, when the operation of the image generation system 10 according to the modified example of the eighth example embodiment is started, first, an image is inputted to the perturbed image generation unit 170 (the step S61). When the image is inputted, the perturbed image generation unit 170 generates M perturbed images from the image (the step 62).

Subsequently, the detection unit 110 detects the position informations about the position of the face or the position of the feature point of the face, respectively, from (M+1) images (i.e., one original image+M perturbed images) (step S63). As a result, (M+1) position informations are detected.

Subsequently, the probability distribution estimation unit 160 performs the process of fitting the predetermined probability distribution to the (M+1) position informations (step S65). Then, the sampling unit 123 samples one position information from the probability distribution that is outputted as the processing result of the probability distribution estimation unit 160 (step S66).

Then, the generation unit 130 performs the process of normalizing the face on the basis of the sampled position information (i.e., the perturbed position information) (the step S21). The generation unit 130 outputs the face normalized image that is an image including the normalized face, as a new image (the step S22).

### (Technical Effect)

Next, a technical effect obtained by the image generation system 10 according to the modified example of the eighth example embodiment will be described.

As described in FIG. 19 and FIG. 20, in the image generation system 10 according to the modified example of the eighth example embodiment, since the M perturbed images are generated by the perturbed image generation unit 170, the (M+1) position informations are detected as a consequence. Then, the probability distribution is fitted to the (M+1) position informations, and the position information sampled from the distribution is used as the perturbed position information for generating a new image. In this way, it is possible to obtain the perturbed position information from the probability distribution estimated from the (M+1) position informations. Therefore, it is possible to properly generate a new face image including the position variation according to the error.

### Ninth Example Embodiment

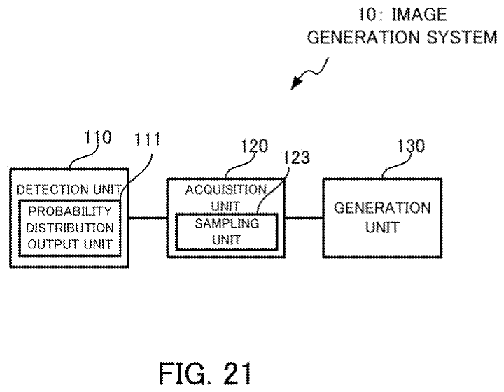

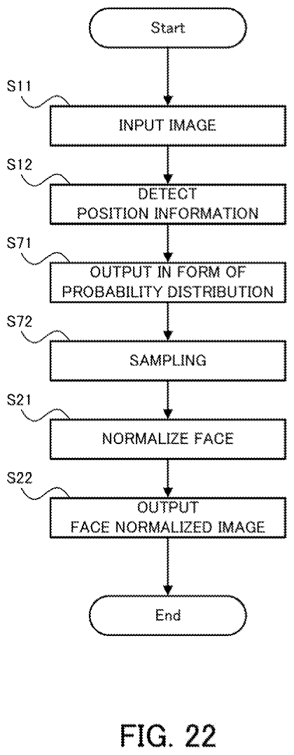

The image generation system 10 according to a ninth example embodiment will be described with reference to FIG. 21 and FIG. 22. The ninth example embodiment is partially different from the first to eighth example embodiments only in the configuration and operation, and may be the same as the first to eighth example embodiments in other parts. For this reason, the parts that differ from the first to eighth example embodiments will be described in detail below, and a description of the other overlapping parts will be omitted as appropriate.

### (Functional Configuration)

First, with reference to FIG. 21, a functional configuration of the image generation system 10 according to the ninth example embodiment will be described. FIG. 21 is a block diagram illustrating the functional configuration of the image generation system according to the ninth example embodiment. In FIG. 21, the same components as those illustrated in FIG. 2, FIG. 15 and FIG. 19 carry the same reference numerals.

As illustrated in FIG. 21, the image generation system 10 according to the ninth example embodiment includes, as processing blocks for realizing its functions, the detection unit 110, the acquisition unit 120, and the generation unit 130. In particular, the detection unit 110 according to the ninth example embodiment includes a probability distribution output unit 111. Furthermore, the acquisition unit 120 according to the ninth example embodiment includes the sampling unit 123.

The probability distribution output unit 111 is configured to output an output result of the detection unit 110 in a form of the probability distribution. Therefore, the detection unit 110 according to the ninth example embodiment is capable of outputting the position information about the position of the face or the position of the feature point of the face detected from the image, in the form of the probability distribution. The detection unit 110 according to the ninth example embodiment may be configured as a detector that performs position estimation in the form of the probability distribution. The detector that performs position estimation in the form of the probability distribution, may deterministically estimate the position information in accordance with a rule determined in advance by the user, such as, for example, a median value, a mean value, and a most frequent value.

The sampling unit 123 is configured to sample one position information from the probability distribution outputted from the probability distribution output unit 111. The position information sampled in this way may be used as the perturbed position information that takes the error into account. The acquisition unit 120 is configured to output the position information sampled by the sampling unit 123 to the generation unit 130, as the perturbed position information.

### (Flow of Operation)

Next, a flow of operation of the image generation system 10 according to the ninth example embodiment will be described with reference to FIG. 22. FIG. 22 is a flowchart illustrating the flow of the operation of the image generation system according to the ninth example embodiment. In FIG. 22, the same steps as those illustrated in FIG. 3 and FIG. 4 carry the same reference numerals.

As illustrated in FIG. 22, when the operation of the image generation system 10 according to the ninth example embodiment is started, first, an image is inputted to the detection unit 110 (the step S11). When the image is inputted, the detection unit 110 detects the position information about the position of the face or the position of the feature point of the face from the image (the step S12).

Subsequently, the probability distribution output unit 111 outputs a detection result of the detection unit 110 in the form of the probability distribution (step S71). Then, the sampling unit 123 samples one position information from the probability distribution that is outputted as the detection result of the detection unit 110 (step S72).

Then, the generation unit 130 performs the process of normalizing the face on the basis of the sampled position information (i.e., the perturbed position information) (the step S21). The generation unit 130 outputs the face normalized image that is an image including the normalized face, as a new image (the step S22).

### (Technical Effect)

Next, a technical effect obtained by the image generation system 10 according to the ninth example embodiment will be described.

As described in FIG. 21 and FIG. 22, in the image generation system 10 according to the ninth example embodiment, the detection result of the detection unit 110 is outputted in the form of the probability distribution, and the position information sampled from the distribution is used as the perturbed position information for generating a new image. In this way, it is possible to obtain the perturbed position information from the probability distribution that is the detection result of the detection unit 110. Therefore, it is possible to properly generate a new face image including a variation in position corresponding to the error.

### Tenth Example Embodiment

The image generation system according to a tenth example embodiment will be described. The tenth example embodiment describes specific application examples of the image generation systems according to the first to ninth example embodiments, and may be the same as the first to ninth example embodiments in the system configuration and the flow of operation. For this reason, the parts that differ from the first to ninth example embodiments will be described in detail below, and a description of the other overlapping parts will be omitted as appropriate.

### (Enhancement of Training Data)

The image generation system 10 according to the tenth example embodiment may be used to enhance training data that are used for machine learning. According to the image generation system 10 in this example embodiment, since a different image can be newly generated from one image included in the training data, it is possible to increase the numbers of images included in the training data. By enhancing the training data in this way, it is possible to increase versatility and robustness.

It is conceivable to adopt such processes as, for example, segmenting, reducing and enlarging, and rotating the image, to a method of enhancing the training data, but even if the training data are enhanced in this way, it is hard to increase the robustness of a variation in position in the face normalization, for example.

In the image generation system 10 according to this example embodiment, however, as already described, the perturbation is applied in accordance with the error that occurs when the position information about the position of the face or the position of the feature point of the face is detected. Therefore, it is possible to increase the robustness of a variation in position in the normalization process that uses the position information about the position of the face or the position of the feature point of the face.

### (Application to Generative Adversarial Network)

The image generation system 10 according to the tenth example embodiment may be used for Virtual Adversarial Training. Specifically, the image generation system 10 may be configured to generate an adversarial example in the Virtual Adversarial Training.

When the adversarial example is generated, an artificial minute noise is added to learning data such that recognition is hardly made by a machine. If, however, it is not considered whether generated data are along a distribution of the learning data, the noisy data that do not actually exist may be generated. It cannot be said that the adversarial example generated in this way contributes to an improvement in learning of a neural network.

In the image generation system 10 according to this example embodiment, however, the perturbation is applied in accordance with the error that occurs when the position information about the position of the face or the position of the feature point of the face is detected. Therefore, by combining the adversarial example for a position of the feature point obtained by the Virtual Adversarial Training with the perturbed position information obtained by the image generation system 10, it is possible to surely enhance an effect of the Virtual Adversarial Training. A method of the combination may use known techniques/technologies of vector/sequence integration, such as mean or projection.

### (Identification of Person)

The image generation system 10 according to the tenth example embodiment may also be applied to identification of a person (so-called face authentication). For example, by using a plurality of images generated by the image generation system 10 according to this example embodiment (images to which the perturbation is applied in accordance with the error), it is possible to suppress a reduction in authentication accuracy.

In the person identification, there is a possibility that a normal identification cannot be made depending on a degree of appearance of the face in the image. In this case, for example, there may be circumstances in which a person who is normally to be authenticated is not authenticated, or a person who is not to be authenticated is authenticated.

In the image 10 according to this example embodiment, however, it is possible to nearly generate a different face image from a single face image. Therefore, it is possible to perform the identification of a person by using a plurality of face images (or by selecting an appropriate face image from the plurality of face images). Furthermore, especially in this example embodiment, the perturbation is applied in accordance with the error that occurs when the position information about the position of the face or the position of the feature point of the face is detected. Therefore, it is possible to generate an appropriate image by considering a variation in position of the feature point used for the identification of a person. Consequently, it is possible to effectively increase the accuracy of the authentication by the identification of a person.

### (Maximization of Identification Accuracy)

In the identification of a person, the perturbation quantity may be calculated to provide the highest identification accuracy when the identification is made under a specific environment. Specifically, it is sufficient to obtain a coefficient that allows the identification accuracy to be maximized when the perturbation quantity is calculated by multiplying the error parameter by a coefficient of 0 to 1.

### (Integration of Feature Quantities)

In the identification of a person, an integrated feature quantity obtained by integrates N feature quantities may be obtained. Specifically, first, N face normalized images are generated from N perturbed position informations by the image generation system 10 according to this example embodiment. Then, face feature quantities are respectively extracted from N face normalized images to generate N feature quantities. Finally, one integrated feature quantity is generated from the N feature quantities by using an arbitrary feature quantity integration method. Existing techniques/technologies, such as, for example, mean and Gaussian estimation, can be properly adopted to the feature quantity integration method.

### (Selection of Image for Identification)

In the identification of a person, an image that is used for the identification may be selectable. Specifically, the generated face normalized images are displayed on a display, and are presented to a user (i.e., a person who is to be authenticated or a system administrator or manager, etc.). Then, the user may be allowed to select an image to be used for the authentication, from among the presented face normalized images. In this case, the images may be ranked, and the images that are more suitable for the identification may be displayed in higher order. In addition, only a predetermined number of images suitable for the identification may be displayed. In addition to the image display, a sentence like “Are the eyes out of position?” may be displayed to obtain a response from the user.

### (Montage Creation)

The image generation system 10 according to the tenth example embodiment may be used to create a montage. When the montage is created, a part of the face is changed little by little, but efficient creation is hardly possible without a proper change. For example, even if a change that is impossible as a human face is given, it is hardly possible to generate an appropriate montage.

In the image generation system 10 according to this example embodiment, however, the perturbation is applied in accordance with the error that occurs when the position information about the position of the face or the position of the feature point of the face is detected. Thus, it is possible to give a proper change that can be realistically expected, to the face image. Therefore, by applying the image generated by the image generation system 10 according to this example embodiment to the montage creation, it is possible to create a montage, more efficiently.

### Supplementary Notes

The example embodiments described above may be further described as, but not limited to, the following Supplementary Notes below.

### (Supplementary Note 1)

An image generation system described in Supplementary Note 1 is an image generation system including: a detection unit that detects a position information about a position of a face or a position of a feature point of the face from an image; an acquisition unit that obtains a perturbed position information that takes into account an error that occurs when the position information is detected, for the position information; and a generation unit that generates a new image including the face on the basis of the perturbed position information.

### (Supplementary Note 2)

An image generation system described in Supplementary Note 2 is the image generation system described in Supplementary Note 1, wherein the generation unit generates, as the new image, a normalized image obtained by adjusting at least one of a position, a size, and an angle of the face on the basis of the perturbed position information.

### (Supplementary Note 3)

An image generation system described in Supplementary Note 3 is the image generation system described in Supplementary Note 1 or 2, further including a calculation unit that calculates a perturbation quantity corresponding to the error, wherein the acquisition unit obtains the perturbed position information by adding the perturbation quantity to the position information.

### (Supplementary Note 4)

An image generation system described in Supplementary Note 4 is the image generation system described in Supplementary Note 3, wherein the calculation unit calculates the perturbation quantity in accordance with the error that is specified by a user.

### (Supplementary Note 5)

An image generation system described in Supplementary Note 5 is the image generation system described in Supplementary Note 3, further including an error evaluation unit that evaluates the error by using an image for a test having correct answer data about the position information, wherein the calculation unit calculates the perturbation quantity in accordance with the evaluated error.

### (Supplementary Note 6)

An image generation system described in Supplementary Note 6 is the image generation system described in Supplementary Note 3, wherein the calculation unit calculates the perturbation quantity in accordance with a deviation of a probability distribution of a plurality of position informations.

### (Supplementary Note 7)

An image generation system described in Supplementary Note 6 is the image generation system described in Supplementary Note 1 or 2, wherein the acquisition unit obtains the perturbed position information on the basis of a plurality of position informations detected by one detection unit.

### (Supplementary Note 8)

An image generation system described in Supplementary Note 8 is the image generation system described in Supplementary Note 7, wherein the acquisition unit obtains the perturbed position information on the basis of a plurality of position informations detected by a plurality of different detection units.

### (Supplementary Note 9)

An image generation system described in Supplementary Note 9 is the image generation system described in Supplementary Note 7 or 8, further including a probability distribution estimation unit that estimates a probability distribution from a plurality of position informations, wherein the acquisition unit obtains the perturbed position information by sampling from the estimated probability distribution.

### (Supplementary Note 10)

An image generation system described in Supplementary Note 10 is the image generation system described in Supplementary Note 1 or 2, further including a perturbed image generation unit that generates a plurality of perturbed images by perturbing the image, wherein the acquisition unit obtains the perturbed position information on the basis of a plurality of position informations detected for each of the plurality of perturbed images.

### (Supplementary Note 11)

An image generation system described in Supplementary Note 11 is the image generation system described in Supplementary Note 1 or 2, wherein the detection unit outputs the position information in a form of a probability distribution, and the acquisition unit obtains the perturbed position information by sampling from the outputted probability distribution.

### (Supplementary Note 12)

An image generation method described in Supplementary Note 12 is an image generation method including: detecting a position information about a position of a face or a position of a feature point of the face from an image; obtaining a perturbed position information that takes into account an error that occurs when the position information is detected, for the position information; and generating a new image including the face on the basis of the perturbed position information.

### (Supplementary Note 13)

A recording medium described in Supplementary Note 13 is a recording medium on which a computer program that allows a computer to execute an image generation method is recorded, the image generation method including: detecting a position information about a position of a face or a position of a feature point of the face from an image; obtaining a perturbed position information that takes into account an error that occurs when the position information is detected, for the position information; and generating a new image including the face on the basis of the perturbed position information.

This disclosure is not limited to the examples described above and is allowed to be changed, if desired, without departing from the essence or spirit of this disclosure which can be read from the claims and the entire specification. An image generation system, an image generation method, and a recording medium with such changes are also intended to be within the technical scope of this disclosure.

### DESCRIPTION OF REFERENCE CODES

10 Image generation system
11 Processor
110 Detection unit
111 Probability distribution output unit
120 Acquisition unit
121 Perturbation addition unit
122 Selection unit
123 Sampling unit
130 Generation unit
140 Perturbation quantity generation unit
150 Error evaluation unit
160 Probability distribution estimation unit
170 Perturbed image generation unit

What is claimed is:

1. An image generation system comprising:
at least one memory that is configured to store instructions; and
at least one first processor that is configured to execute the instructions to
detect a position information about a position of a face or a position of a feature point of the face from an image;
obtain a perturbed position information that takes into account an error that occurs when the position information is detected, for the position information; and
generate a new image including the face on the basis of the perturbed position information.

2. The image generation system according to claim 1, wherein the at least one first processor is configured to execute the instructions to generate, as the new image, a normalized image obtained by adjusting at least one of a position, a size, and an angle of the face on the basis of the perturbed position information.

3. The image generation system according to claim 1, further comprising a second processor that is configured to execute instructions to calculate a perturbation quantity corresponding to the error, wherein
the at least one first processor is configured to execute the instructions to obtain the perturbed position information by adding the perturbation quantity to the position information.

4. The image generation system according to claim 3, wherein the second processor is configured to execute instructions to calculate the perturbation quantity in accordance with the error that is specified by a user.

5. The image generation system according to claim 3, further comprising a third processor that is configured to execute instructions to evaluate the error by using an image for a test having correct answer data about the position information, wherein
the second processor is configured to execute instructions to calculate the perturbation quantity in accordance with the evaluated error.

6. The image generation system according to claim 3, wherein the second processor is configured to execute instructions to calculate the perturbation quantity in accordance with a deviation of a probability distribution of a plurality of position informations.

7. The image generation system according to claim 1, wherein the at least one first processor is configured to execute the instructions to obtain the perturbed position information on the basis of a plurality of position informations detected by one first processor.

8. The image generation system according to claim 7, wherein the at least one first processor is configured to execute the instructions to obtain the perturbed position information on the basis of a plurality of position informations detected by a plurality of different first processors.

9. The image generation system according to claim 7, further comprising a fourth processor that is configured to execute instructions to estimate a probability distribution from a plurality of position informations, wherein
the at least one first processor is configured to execute the instructions to obtain the perturbed position information by sampling from the estimated probability distribution.

10. The image generation system according to claim 1, further comprising a fifth processor that is configured to execute instructions to generate a plurality of perturbed images by perturbing the image, wherein
the at least one first processor is configured to execute the instructions to obtain the perturbed position information on the basis of a plurality of position informations detected for each of the plurality of perturbed images.

11. The image generation system according to claim 1, wherein
the at least one first processor is configured to execute the instructions to output the position information in a form of a probability distribution, and
the at least one first processor is configured to execute the instructions to obtain the perturbed position information by sampling from the outputted probability distribution.

12. An image generation method comprising:
detecting a position information about a position of a face or a position of a feature point of the face from an image;
obtaining a perturbed position information that takes into account an error that occurs when the position information is detected, for the position information; and
generating a new image including the face on the basis of the perturbed position information.

13. A non-transitory recording medium on which a computer program that allows a computer to execute an image generation method is recorded, the image generation method including:
detecting a position information about a position of a face or a position of a feature point of the face from an image;
obtaining a perturbed position information that takes into account an error that occurs when the position information is detected, for the position information; and
generating a new image including the face on the basis of the perturbed position information.
